(19) United States
(12) Patent Application Publication
(10) Pub. No.: US 2005/0161142 A1
(43) Pub. Date: Jul. 28, 2005

(54) Low cost conductive brushes manufactured from conductive loaded resin-based materials

(75) Inventor: Thomas Aisenbrey, Littleton, CO (US)

Correspondence Address: STEPHEN B. ACKERMAN, 28 DAVIS AVENUE, POUGHKEEPSIE, NY, 12603, US

(73) Assignee: Integral Technologies, Inc.

(21) Appl. No.: 11/083,599

(22) Filed: Mar. 18, 2005

Related U.S. Application Data
(63) Continuation-in-part of application No. 10/877,092, filed on Jun. 25, 2004.
Application No. 10/877,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/557,891, filed on Mar. 31, 2004.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. B32B 31/00

(52) U.S. Cl. 156/72; 300/21

(57) ABSTRACT

Conductive brushes are formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are formed from non-metals, such as carbon, graphite, that may also be metallic plated, or the like, or from metals such as stainless steel, nickel, copper, silver, that may also be metallic plated, or the like, or from a combination of non-metal, plated, or in combination with, metal powders. The micron conductor fibers preferably are of nickel plated carbon fiber, stainless steel fiber, copper fiber, silver fiber, aluminum fiber, or the like.

This patent application claims priority to the U.S. Provisional Patent Application 60/557,891 filed on Mar. 31, 2004, which is herein incorporated by reference in its entirety.

This patent application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001.

### BACKGROUND OF THE INVENTION

(1) Field of the Invention

This invention relates to conductive brushes and, more particularly, to conductive brushes molded of conductive loaded resin-based materials comprising micron conductive powders, micron conductive fibers, or a combination thereof, substantially homogenized within a base resin when molded. This manufacturing process yields a conductive part or material usable within the EMF or electronic spectrum(s).

(2) Description of the Prior Art

Brushes are used in a variety of consumer and industrial applications. Typical brushes comprise a handle onto which is attached a plurality of bristles. Such bristles can be employed for brushing, wiping, scraping, cleaning, and the like, as directed by the user holding the brush handle. In many cases, it is not particularly important whether the bristles or the handle of the brush are electrical conductors or insulators or whether the brush generates static electricity during use. However, in certain applications, these characteristics are important.

In the art of electronics manufacturing there are circumstances where it is useful or even necessary to use a brushing device to clean an electronic device. For example, it is often necessary to use a brush to clean circuit board edge connectors prior to system assembly. It is important that the movement of the cleaning brush not generate electrostatic charge on the circuit board. Electrostatic charge build-up can create very large voltages that will seek a pathway to release the static energy. Much as occurs when a person walks across a carpet in a low humidity environment, this static charge can generate a significant event when it is discharged. Modern electronic devices, such as integrated circuits, contain very fine critical features. Small circuit features, typified by small circuit conductive lines, thin MOS transistor gate oxides, shallow semiconductor junctions, and the like, are typically more susceptible to the effects of electrostatic discharge (ESD) or electrical overstress (EOS). Static generation and dissipative problems have grown in integrated circuit fabrication and in electronic component manufacturing as electronic circuit features have become smaller.

It is found that electrical static charge is generated through friction, through pressure, or through separation of two materials, usually when one is non-conductive. This is commonly referred to as the triboelectric effect. Material composition, applied forces, separation rate, and relative humidity determine the magnitude of the static charge. A material that inhibits the generation of static charges from triboelectric generation is classified as antistatic. An antistatic material can be conductive, dissipative, or even insulative. To prevent ESD events, it is necessary to handle a circuit carefully. As a general precaution, any person handling a circuit board device or an integrated circuit device should be physically attached to ground through a grounding strap. Furthermore, any other objects that come in contact with electronics device should be connected by a low impedance path to ground, if possible.

Brushes are used in integrated circuit and electronic component fabrication for applying material to a surface, for pushing or spreading applied material, for removing excess applied material, for cleaning a surface of a component, for acting as a barrier for applied material to prevent excess spreading, and the like. In particular, brushes are used for solder removal, dusting/dirt removal, circuit board preparation, and rework, lead trimming rework, edge connector cleaning, static dissipation, wiping, and the like. In addition, brushing devices are frequently used in applications such as paper conversion, printing, copying, film processing, material handling and packaging. If a brushing operation is needed in an application where static discharge must be avoided, then the brush should be a type that does not generate static charge and/or a type that is sufficiently conductive to dissipate any static charge.

A useful method for reducing the possibility of an ESD event is to use a conductive brush. A conductive brush allows any static charge to move freely on the brush such that the charge is rapidly equalized across the entire brush. If the brush is tied to ground, then it will dissipate any static charge to ground. The present invention concerns conductive brush devices and methods for forming conductive brushes.

Several prior art inventions relate to conductive and/or antistatic brushes. U.S. Pat. No. 4,641,949 to Wallace et al teaches a conductive brush paper position sensor comprising oppositely disposed conductive fiber brushes that detect the presence of paper. This invention teaches that the brushes are made from poly-acrylo-nitrile conductive polymer. U.S. Pat. No. 5,689,791 to Swift teaches of electro-conductive fibers that utilize electrically conductive filler, such as carbon black, suffused through or coated on the surface of the filamentary polymer substrate. The electro-conductive fibers of this invention are used for miniature cleaning brushes for an image forming apparatus. U.S. Pat. No. 6,009,301 to Maher et al teaches a cleaning brush with insulated fibers with conductive cores and a conductive backing for use in an electrostatographic reproduction apparatus. U.S. Pat. No. 5,339,143 to Kunzmann teaches a developer unit conductive brush with carbon fiber bristles that are about 6 to 20 microns in diameter and 12 millimeters in length. U.S. Patent Application 2004/0086309 A1 to Ohara et al teaches a conductive brush and its method of manufacture that utilizes synthetic resin and conductive filler material, including metal, metal oxide, or carbon, for manufacturing the bristles and the substrate in order to render it conductive. U.S. Pat. No. 4,336,028 to Tomibe et al teaches a method of making electrically conducting fibers that utilizes a process to allow copper sulfide to be absorbed into the fibers.

### SUMMARY OF THE INVENTION

A principal object of the present invention is to provide an effective conductive brush.

A further object of the present invention is to provide a method to form conductive brushes.

A further object of the present invention is to provide conductive brushes molded of conductive loaded resin-based materials.

A yet further object of the present invention is to provide conductive brushes molded of conductive loaded resin-based material where a metal layer is formed over the conductive loaded resin-based material.

A yet further object of the present invention is to provide methods to fabricate conductive brushes from a conductive loaded resin-based material incorporating various forms of the material.

A yet further object of the present invention is to provide a method to fabricate conductive brushes from a conductive loaded resin-based material where the material is in the form of a fabric.

In accordance with the objects of this invention, a conductive brush device is achieved. The device comprises a plurality of conductive bristles comprising conductive loaded, resin-based material comprising conductive materials in a base resin host. A conductive frame is attached to the plurality of conductive bristles.

Also in accordance with the objects of this invention, a conductive brush device is achieved. The device comprises a plurality of conductive bristles comprising conductive loaded, resin-based material comprising conductive materials in a base resin host. A conductive handle comprising the conductive loaded resin-based material is attached to the conductive bristles. The weight of the conductive materials is between 0.20% and 50% of the total weight of the conductive loaded resin-based material.

Also in accordance with the objects of this invention, a conductive brush device is achieved. The conductive brush comprises a plurality of conductive bristles comprising conductive loaded, resin-based material comprising micron conductive fiber in a base resin host. A conductive handle comprises the conductive loaded resin-based material. The plurality of conductive bristles is attached to the conductive frame. The weight of the micron conductive fiber is between 20% and 50% of the total weight of the conductive loaded resin-based material.

Also in accordance with the objects of this invention, a method to form a conductor brush device is achieved. The method comprises providing a conductive loaded, resin-based material comprising conductive materials in a resin-based host. The conductive loaded, resin-based material is molded into a plurality of conductive bristles. The conductive bristles are attached to a conductive frame.

Also in accordance with the objects of this invention, a method to form a conductive brush device is achieved. The method comprises providing a conductive loaded, resin-based material comprising conductive materials in a resin-based host. The percent by weight of the conductive materials is between 20% and 50% of the total weight of the conductive loaded resin-based material. The conductive loaded, resin-based material is molded into a conductive brush device comprising a plurality of conductive bristles and a conductive handle. The conductive bristles are attached to the conductive handle.

Also in accordance with the objects of this invention, a method to form a conductive brush device is achieved. The method comprises providing a conductive loaded, resin-based material comprising micron conductive fiber in a resin-based host. The percent by weight of the micron conductive fiber is between 25% and 35% of the total weight of the conductive loaded resin-based material. The conductive loaded, resin-based material is molded into a conductive brush device comprising a plurality of conductive bristles and a conductive handle that is attached to the conductive bristles.

### BRIEF DESCRIPTION OF THE DRAWINGS

In the accompanying drawings forming a material part of this description, there is shown:

FIGS. 1a and 1b illustrate first and second preferred embodiments of the present invention showing conductive brushes comprising a conductive loaded resin-based material.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold conductive brushes of a conductive loaded resin-based material.

FIG. 7 illustrates a third preferred embodiment of the present invention showing a cylindrical, rotating conductive brush of conductive loaded resin-based material.

FIG. 8 illustrates a fourth preferred embodiment of the present invention showing a conductive hand brush of conductive loaded resin-based material.

FIG. 9 illustrates a fifth preferred embodiment of the present invention showing a conductive long handle brush of conductive loaded resin-based material.

FIG. 10 illustrates a sixth preferred embodiment of the present invention showing a conductive broom of conductive loaded resin-based material.

FIG. 11 illustrates a seventh preferred embodiment of the present invention showing a conductive comb of conductive loaded resin-based material.

### DESCRIPTION OF THE PREFERRED EMBODIMENTS

This invention relates to conductive brushes molded of conductive loaded resin-based materials comprising micron conductive powders, micron conductive fibers, or a combination thereof, substantially homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are substantially homogenized within the resin during the molding process, providing the electrical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of conductive brushes fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the conductive brushes devices are substantially homogenized together using molding techniques and or methods such as injection molding, over-molding, insert molding, thermo-set, protrusion, extrusion or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

In the conductive loaded resin-based material, electrons travel from point to point when under stress, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive loading concentration, that is, the separation between the conductive loading particles. Increasing conductive loading content reduces interparticle separation distance, and, at a critical distance known as the percolation point, resistance decreases dramatically and electrons move rapidly.

The use of conductive loaded resin-based materials in the fabrication of conductive brushes significantly lowers the cost of materials and the design and manufacturing processes used to hold ease of close tolerances, by forming these materials into desired shapes and sizes. The conductive brushes can be manufactured into infinite shapes and sizes using conventional forming methods such as injection molding, over-molding, or extrusion or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are substantially homogenized together within the base resin, during the molding process, yielding an easy to produce low cost, electrically conductive, close tolerance manufactured part or circuit. The resulting molded article comprises a three dimensional, continuous network of conductive loading and polymer matrix. The micron conductive powders can be of carbons, graphites, amines or the like, and/or of metal powders such as nickel, copper, silver, aluminum, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. The micron conductive fibers can be nickel plated carbon fiber, stainless steel fiber, copper fiber, silver fiber, aluminum fiber, or the like, or combinations thereof. The structural material is a material such as any polymer resin. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion to create desired shapes and sizes. The molded conductive loaded resin-based materials can also be stamped, cut or milled as desired to form create the desired shape form factor(s) of the conductive brushes. The doping composition and directionality associated with the micron conductors within the loaded base resins can affect the electrical and structural characteristics of the conductive brushes and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming conductive brushes that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in conductive brush applications as described herein.

The substantially homogeneous mixing of micron conductive fiber and/or micron conductive powder and base resin described in the present invention may also be described as doping. That is, the substantially homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder into a base resin.

As an additional and important feature of the present invention, the molded conductor loaded resin-based material exhibits excellent thermal dissipation characteristics. Therefore, conductive brushes manufactured from the molded conductor loaded resin-based material can provide added thermal dissipation capabilities to the application. For example, heat can be dissipated from electrical devices physically and/or electrically connected to conductive brushes of the present invention.

As a significant advantage of the present invention, conductive brushes constructed of the conductive loaded resin-based material can be easily interfaced to an electrical circuit or grounded. In one embodiment, a wire can be attached to a conductive loaded resin-based conductive brushes via a screw that is fastened to the conductive brush. For example, a simple sheet-metal type, self-tapping screw, when fastened to the material, can achieve excellent electrical connectivity via the conductive matrix of the conductive loaded resin-based material. To facilitate this approach a boss may be molded into the conductive loaded resin-based material to accommodate such a screw. Alternatively, if a solderable screw material, such as copper, is used, then a wire can be soldered to the screw that is embedded into the conductive loaded resin-based material. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the conductive brush and a grounding wire.

A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

Another method to provide connectivity to the conductive loaded resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductive loaded resin-based material at the location of the applied solderable ink. Many other types of solderable inks can be used to provide this solderable surface onto the conductive loaded resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductive loaded resin-based material may be formed of the present invention to create a magnetic or magnetizable form of the material. Ferromagnetic micron conductive fibers and/or ferromagnetic conductive powders are mixed with the base resin. Ferrite materials and/or rare earth magnetic materials are added as a conductive loading to the base resin. With the substantially homogeneous mixing of the ferromagnetic micron conductive fibers and/or micron conductive powders, the ferromagnetic conductive loaded resin-based material is able to produce an excellent low cost, low weight magnetize-able item. The magnets and magnetic devices of the present invention can be magnetized during or after the molding process. The magnetic strength of the magnets and magnetic devices can be varied by adjusting the amount of ferromagnetic micron conductive fibers and/or ferromagnetic micron conductive powders that are incorporated with the base resin. By increasing the amount of the ferromagnetic doping, the strength of the magnet or magnetic devices is increased. The substantially homogenous mixing of the conductive fiber network allows for a substantial amount of fiber to be added to the base resin without causing the structural integrity of the item to decline. The ferromagnetic conductive loaded resin-based magnets display the excellent physical properties of the base resin, including flexibility, moldability, strength, and resistance to environmental corrosion, along with excellent magnetic ability. In addition, the unique ferromagnetic conductive loaded resin-based material facilitates formation of items that exhibit excellent thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fiber to cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductive loaded resin-based material may be magnetized, after molding, by exposing the molded article to a strong magnetic field. Alternatively, a strong magnetic field may be used to magnetize the ferromagnetic conductive loaded resin-based material during the molding process.

Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary non-ferromagnetic conductor fibers include stainless steel, nickel, copper, silver, aluminum, or other suitable metals or conductive fibers, alloys, plated materials, or combinations thereof. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials.

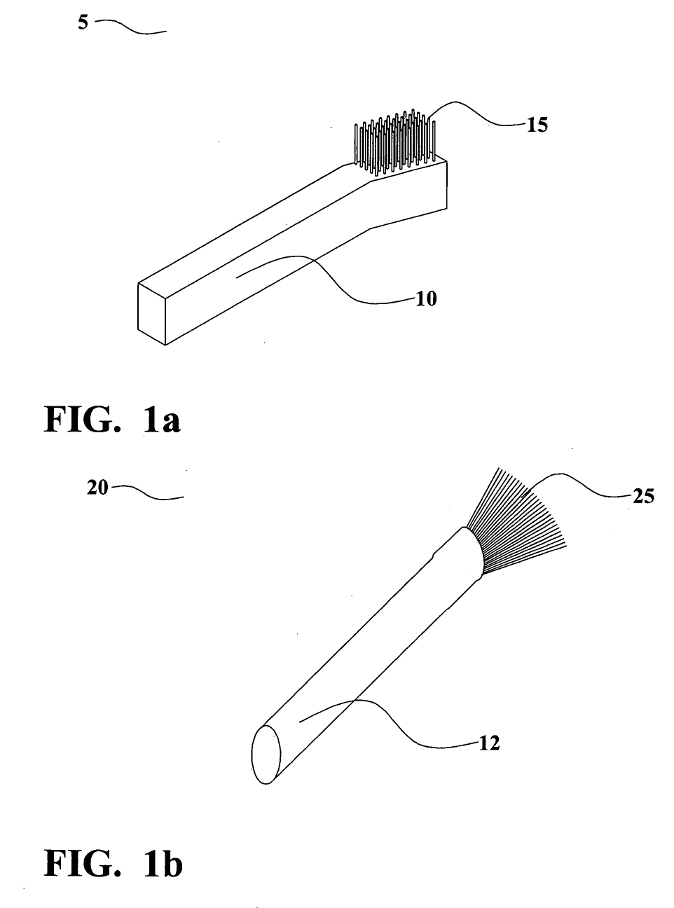

Referring now to FIGS. 1a and 1b, first and second preferred embodiments of the present invention are illustrated. Very low cost, flexible, electrically conductive brushes comprising conductive loaded resin-based materials are shown. Several important features of the present invention are shown and discussed below. In particular, FIG. 1a illustrates one of the preferred approaches for conductive loaded resin-based materials in realizing a very low cost electrically conductive brush. An electrically conductive brush 5 is formed of the conductive loaded resin-based materials of this invention. The electrically conductive brush 5 has bristles 15 secured to a handle 10. In the preferred embodiment, both bristles 15 and the handle 10 comprise the conductive loaded resin-based materials as described herein. In another embodiment, the bristles 15 comprise the conductive loaded resin-based material while the handle 10 does not. In another embodiment, the handle 10 comprises the conductive loaded resin-based material while the bristles 15 do not.

The bristles 15 are formed by any conventional technique for molding resin-based bristles, such as extrusion, as is known in the art. In one embodiment, the bristles 15 are co-molded with the handle 10. In another embodiment, the bristles 15 are adhered to the handle 10. In this case, the bristles 15 are first formed and then are inserted into openings of the handle 10. The bristles 15 are adhered in the handle 10 by ultrasonic welding, by thermal welding, or by a chemical solvent to cause the conductive loaded resin-based materials of the bristles to mix with those of the handle 10. Alternatively, a conductive adhesive is applied to join the bristles 15 to the handle 10. In another embodiment, a ferromagnetic material is added to the conductive loading to create a magnetic conductive loaded resin-based material for the bristles 15 and/or the handle 10. In this way, a magnetized and conductive brush 5 is formed.

Referring particularly, to FIG. 1b, a second preferred embodiment of a conductive brush 20 of the present invention is shown. In this embodiment, the handle 12 of the brush 20 is cylindrical and formed of the conductive loaded resin-based materials. The bristles 25 are bunched for placing in an opening of the end of the cylinder shape of the handle 12. The electrically conductive brush 20 has bristles 25 secured to the handle 12. In the preferred embodiment, both bristles 25 and handle 12 comprise the conductive loaded resin-based materials as described herein. In another embodiment, the bristles 25 comprise the conductive loaded resin-based material while the handle 12 does not. In another embodiment, the handle 12 comprises the conductive loaded resin-based material while the bristles 25 do not.

The bristles 25 are formed by any conventional technique for molding resin-based bristles, such as extrusion, as is known in the art. In one embodiment, the bristles 25 are co-molded with the handle 12. In another embodiment, the bristles 25 are adhered to the handle 12. In this case, the bristles 25 are first formed and then are inserted into openings of the handle 12. The bristles 25 are adhered in the handle 12 by ultrasonic welding, by thermal welding, or by a chemical solvent to cause the conductive loaded resin-based materials of the bristles to mix with those of the handle 12. Alternatively, a conductive adhesive is applied to join the bristles 25 to the handle 12. In another embodiment, a ferromagnetic material is added to the conductive loading to create a magnetic conductive loaded resin-based material for the bristles 25 and/or the handle 12. In this way, a magnetized and conductive brush 20 is formed.

The electrically conductive brushes 5 and 20 of FIGS. 1a and 1b as described are manufactured of conductive loaded resin-based materials comprising micron conductive powders, micron conductive fibers, or a combination thereof, homogenized within a base resin. The conductive loaded resin-based materials may be cut, stamped, or vacuumed formed from an injection molded or extruded sheet or bar stock, over-molded, laminated, milled or the like to provide the desired electrically conductive brush shape and size. The electrically conductive brushes of FIGS. 1a and 1b are exemplary. The electrically conductive brushes may be shaped into any form necessary for an application.

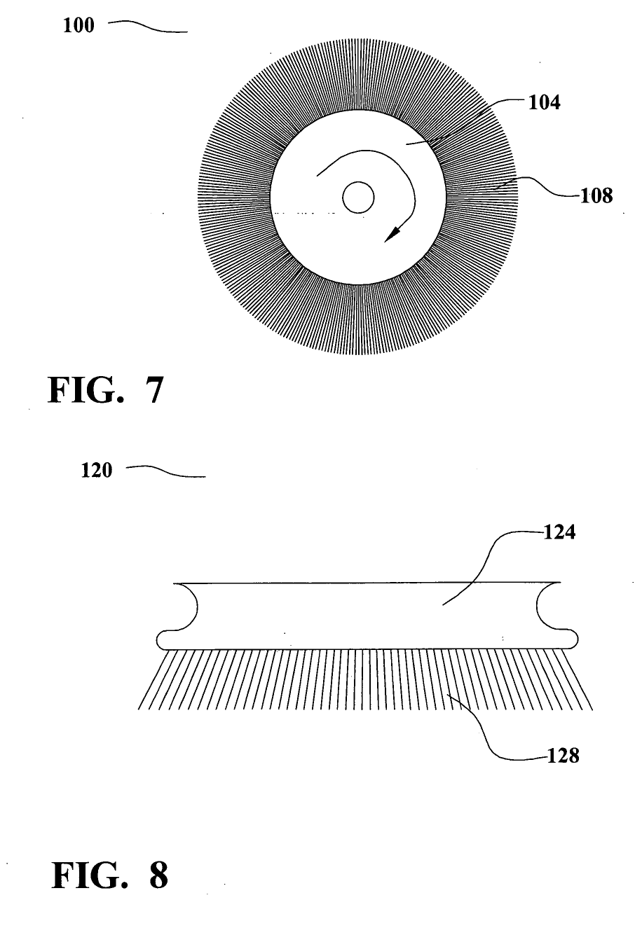

Referring now to FIG. 7, a third preferred embodiment of the present invention is illustrated. A cylindrical, rotating conductive brush 100 is shown. The cylindrical, rotating conductive brush 100 is particularly useful for electrostatic copying and printing applications. In this embodiment, a cylindrical core 104 has bristles 108 radiating outwards. The electrically conductive brush 100 has bristles 108 secured to the core 104. In the preferred embodiment, both bristles 108 and core 104 comprise the conductive loaded resin-based materials as described herein. In another embodiment, the bristles 108 comprise the conductive loaded resin-based material while the core 104 does not. In another embodiment, the core 104 comprises the conductive loaded resin-based material while the bristles 108 do not.

The bristles 108 are formed by any conventional technique for molding resin-based bristles, such as extrusion, as is known in the art. In one embodiment, the bristles 108 are co-molded with the core 104. In another embodiment, the bristles 108 are adhered to the core 104. In this case, the bristles 108 are first formed and then are inserted into openings of the handle 104. The bristles 108 are adhered in the core 104 by ultrasonic welding, by thermal welding, or by a chemical solvent to cause the conductive loaded resin-based materials of the bristles to mix with those of the handle 104. Alternatively, a conductive adhesive is applied to join the bristles 108 to the handle 104. In another embodiment, a ferromagnetic material is added to the conductive loading to create a magnetic conductive loaded resin-based material for the bristles 108 and/or the core 104. In this way, a magnetized and conductive rotary brush 100 is formed.

Referring now to FIG. 8, a fourth preferred embodiment of the present invention is illustrated. A conductive hand brush 120 is shown. A conductive hand brush is useful for tasks, like scrubbing, where heavy pressure should be exerted in the same direction as the bristles 128. In addition, a conductive hand brush 120 may be used for human and/or animal hair brushing. The electrically conductive brush 120 has bristles 128 secured to the handle 124. In the preferred embodiment, both bristles 128 and handle 124 comprise the conductive loaded resin-based materials as described herein. In another embodiment, the bristles 128 comprise the conductive loaded resin-based material while the handle 124 does not. In another embodiment, the handle 124 comprises the conductive loaded resin-based material while the bristles 128 do not.

The bristles 128 are formed by any conventional technique for molding resin-based bristles, such as extrusion, as is known in the art. In one embodiment, the bristles 128 are co-molded with the handle 124. In another embodiment, the bristles 128 are adhered to the handle 124. In this case, the bristles 128 are first formed and then are inserted into openings of the handle 124. The bristles 128 are adhered in the handle 124 by ultrasonic welding, by thermal welding, or by a chemical solvent to cause the conductive loaded resin-based materials of the bristles to mix with those of the handle 124. Alternatively, a conductive adhesive is applied to join the bristles 128 to the handle 124. In another embodiment, a ferromagnetic material is added to the conductive loading to create a magnetic conductive loaded resin-based material for the bristles 128 and/or the handle 124. In this way, a magnetized and conductive brush 120 is formed. Such magnetized brushes are useful for human and/or animal applications where the therapeutic benefits of magnetic fields are desired.

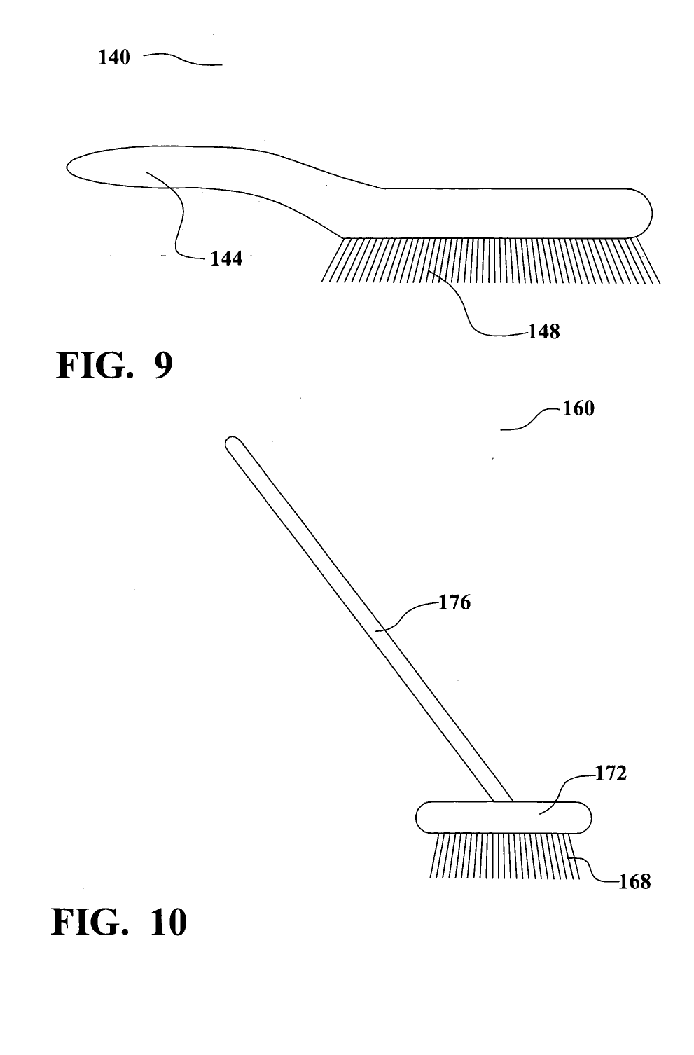

Referring now to FIG. 9, a fifth preferred embodiment of the present invention is illustrated. A conductive long handled hand brush 140 is shown. A conductive long handled brush is useful for larger, work surface sweeping tasks. The electrically conductive brush 140 has bristles 148 secured to the handle 144. In the preferred embodiment, both bristles 148 and handle 144 comprise the conductive loaded resin-based materials as described herein. In another embodiment, the bristles 148 comprise the conductive loaded resin-based material while the handle 144 does not. In another embodiment, the handle 144 comprises the conductive loaded resin-based material while the bristles 148 do not.

The bristles 128 are formed by any conventional technique for molding resin-based bristles, such as extrusion, as is known in the art. In one embodiment, the bristles 148 are co-molded with the handle 144. In another embodiment, the bristles 148 are adhered to the handle 144. In this case, the bristles 148 are first formed and then are inserted into openings of the handle 144. The bristles 148 are adhered in the handle 144 by ultrasonic welding, by thermal welding, or by a chemical solvent to cause the conductive loaded resin-based materials of the bristles to mix with those of the handle 144. Alternatively, a conductive adhesive is applied to join the bristles 148 to the handle 144. In another embodiment, a ferromagnetic material is added to the conductive loading to create a magnetic conductive loaded resin-based material for the bristles 148 and/or the handle 144. In this way, a magnetized and conductive brush 140 is formed.

Referring now to FIG. 10, a sixth preferred embodiment of the present invention is illustrated. A conductive broom 160 is shown. A conductive broom is useful for floor sweeping tasks. The electrically conductive broom 160 has bristles 168 secured to a base handle 172. An extension handle 176 connects to the base handle 172. In the preferred embodiment, both bristles 168 and handles 172 and 176 comprise the conductive loaded resin-based materials as described herein. In another embodiment, the bristles 168 comprise the conductive loaded resin-based material while the handles 172 and 176 do not. In another embodiment, the handles 172 and 176 comprise the conductive loaded resin-based material while the bristles 168 do not.

The bristles 128 are formed by any conventional technique for molding resin-based bristles, such as extrusion, as is known in the art. In one embodiment, the bristles 168 are co-molded with the base handle 172. In another embodiment, the bristles 168 are adhered to the base handle 172. In this case, the bristles 168 are first formed and then are inserted into openings of the handle 172. The bristles 168 are adhered in the handle 172 by ultrasonic welding, by thermal welding, or by a chemical solvent to cause the conductive loaded resin-based materials of the bristles to mix with those of the handle 172. Alternatively, a conductive adhesive is applied to join the bristles 168 to the handle 172. In another embodiment, a ferromagnetic material is added to the conductive loading to create a magnetic conductive loaded resin-based material for the bristles 168 and/or the handle 172 and 176. In this way, a magnetized and conductive broom 160 is formed.

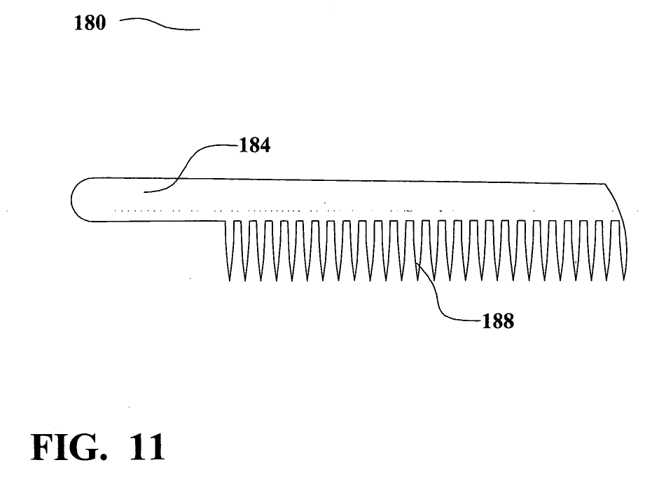

Referring now to FIG. 11, a seventh preferred embodiment of the present invention is illustrated. A conductive comb 180 is shown. A conductive comb is useful for tasks, like scrubbing, where heavy pressure should be exerted in the same direction as the teeth 188. In addition, a conductive comb 180 may be used for human and/or animal hair brushing. The electrically conductive comb 180 has teeth 188 secured to the handle 184. In the preferred embodiment, both teeth 188 and handle 184 comprise the conductive loaded resin-based materials as described herein. In another embodiment, the teeth 188 comprise the conductive loaded resin-based material while the handle 184 does not. In another embodiment, the handle 184 comprises the conductive loaded resin-based material while the teeth 188 do not.

The teeth 188 are formed by any conventional technique for molding resin-based bristles, such as extrusion, as is known in the art. In one embodiment, the teeth 188 are co-molded with the handle 184. In another embodiment, the teeth 188 are adhered to the handle 184. In this case, the teeth 188 are first formed and then are inserted into openings of the handle 184. The teeth 188 are then adhered in the handle 184 by ultrasonic welding, by thermal welding, or by a chemical solvent to cause the conductive loaded resin-based materials of the teeth to mix with those of the handle 184. Alternatively, a conductive adhesive is applied to join the teeth 188 to the handle 184. In another embodiment, a ferromagnetic material is added to the conductive loading to create a magnetic conductive loaded resin-based material for the teeth 128 and/or the handle 184. In this way, a magnetized and conductive comb 180 is formed. Such magnetized combs are useful for human and/or animal applications where the therapeutic benefits of magnetic fields are desired.

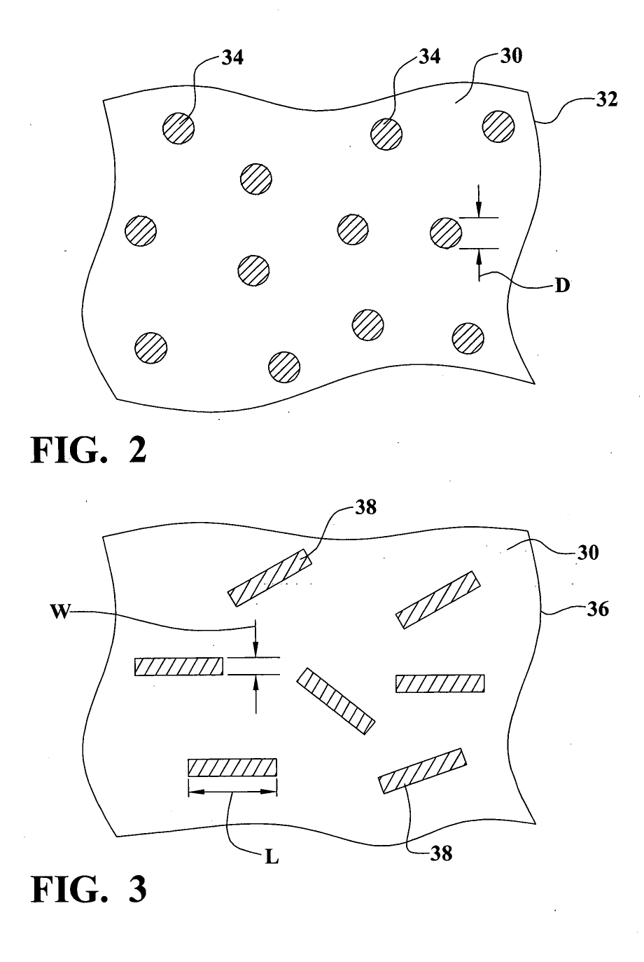

The conductive loaded resin-based material of the present invention typically comprises a micron powder(s) of conductor particles and/or in combination of micron fiber(s) substantially homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

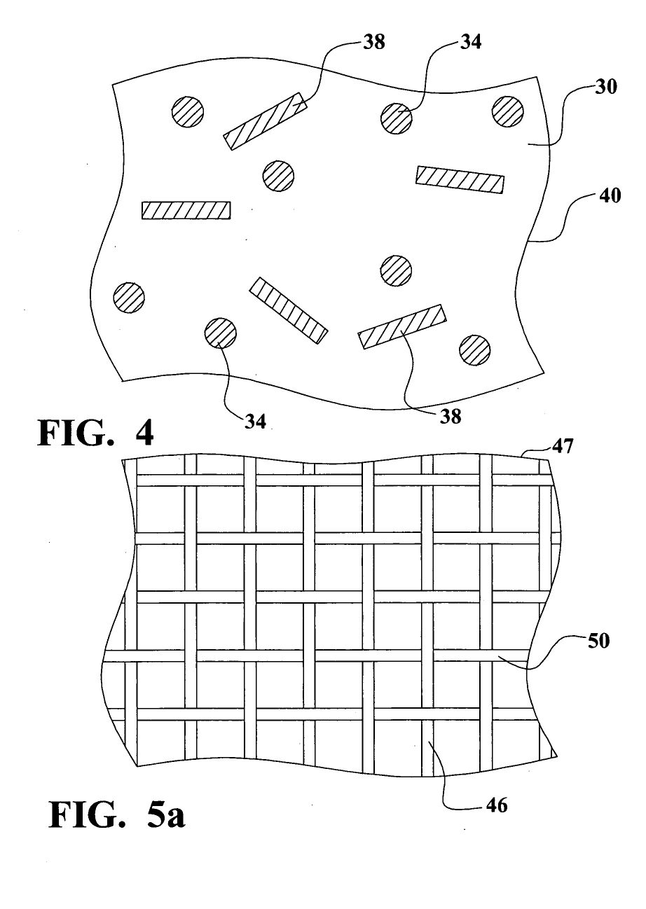

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The conductors used for these conductor particles 34 or conductor fibers 38 can be stainless steel, nickel, copper, silver, aluminum, or other suitable metals or conductive fibers, or combinations thereof. These conductor particles and or fibers are substantially homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 6-12 micron in diameter and lengths of 4-6 mm and comprising, by weight, about 30% of the total weight of the conductive loaded resin-based material will produce a very highly conductive parameter, efficient within any EMF spectrum. Referring now to FIG. 4, another preferred embodiment of the present invention is illustrated where the conductive materials comprise a combination of both conductive powders 34 and micron conductive fibers 38 substantially homogenized together within the resin base 30 during a molding process.

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

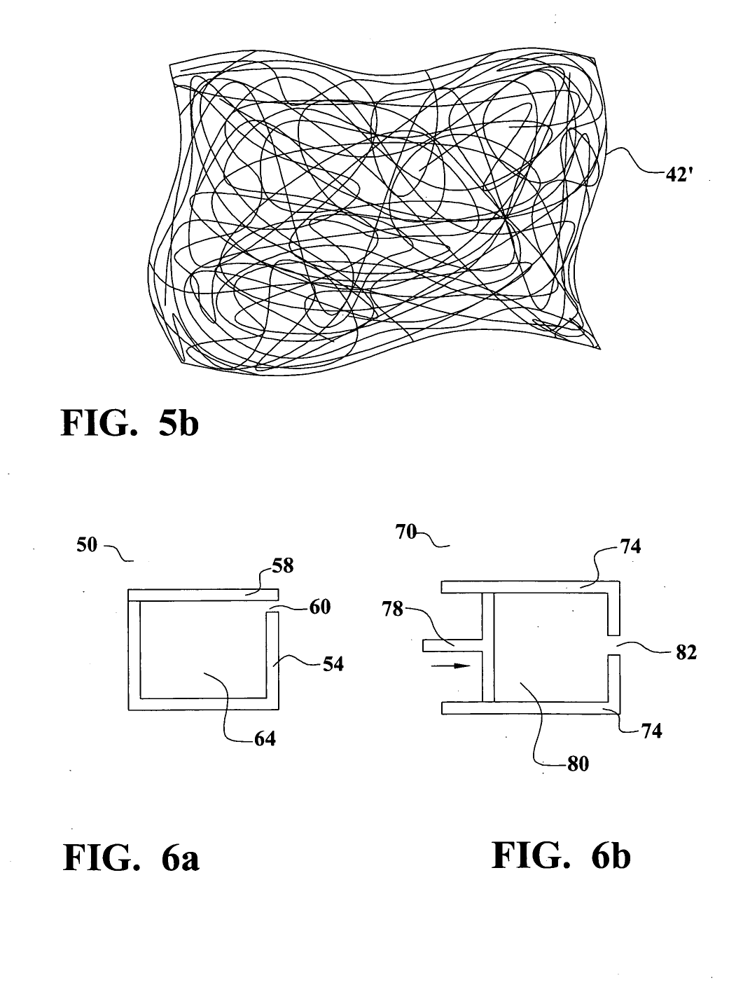

Conductive brushes formed from conductive loaded resin-based materials can be formed or molded in a number of different ways including injection molding, extrusion or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the substantially homogenized conductive material cures by thermal reaction. The upper portion 58 and lower portion 54 of the mold are then separated or parted and the conductive brushes are removed.

FIG. 6b shows a simplified schematic diagram of an extruder 70 for forming conductive brushes using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. An effective conductive brush is achieved. Methods to form conductive brushes are also achieved. The conductive brushes are molded of conductive loaded resin-based materials. Methods to fabricate conductive brushes from a conductive loaded resin-based material incorporating various forms of the material are achieved.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

1. A method to form a conductor brush device, said method comprising:
providing a conductive loaded, resin-based material comprising conductive materials in a resin-based host; and
molding said conductive loaded, resin-based material into a plurality of conductive bristles; and
attaching said conductive bristles to a conductive frame.

2. The method according to claim 1 wherein the percent by weight of said conductive materials is between about 20% and about 50% of the total weight of said conductive loaded resin-based material.

3. The method according to claim 1 wherein said conductive materials comprise micron conductive fiber.

4. The method according to claim 2 wherein said conductive materials further comprise conductive powder.

5. The method according to claim 1 wherein said conductive materials are metal.

6. The method according to claim 1 wherein said conductive frame comprises said conductive loaded resin-based material.

7. The method according to claim 6 wherein said conductive frame is in the shape of a handle.

8. The method according to claim 1 wherein said conductive frame is a cylinder and wherein said conductive bristles radiate from said cylinder.

9. The method according to claim 1 wherein said conductive loaded resin-based material further comprises ferromagnetic loading such that said plurality of bristles is magnetic.

10. The method according to claim 1 wherein said conductive frame comprises said conductive loaded resin-based material and further comprises ferromagnetic loading such that said conductive frame is magnetic.

11. A method to form a conductive brush device, said method comprising:
providing a conductive loaded, resin-based material comprising conductive materials in a resin-based host wherein the percent by weight of said conductive materials is between 20% and 50% of the total weight of said conductive loaded resin-based material; and
molding said conductive loaded, resin-based material into a conductive brush device comprising:
a plurality of conductive bristles; and
a conductive handle that is attached to the conductive bristles.

12. The method according to claim 11 wherein said conductive materials are nickel plated carbon micron fiber, stainless steel micron fiber, copper micron fiber, silver micron fiber or combinations thereof.

13. The method according to claim 11 wherein said conductive materials comprise micron conductive fiber and conductive powder.

14. The method according to claim 13 wherein said conductive powder is nickel, copper, or silver.

15. The method according to claim 13 wherein said conductive powder is a non-conductive material with a metal plating of nickel, copper, silver, or alloys thereof.

16. The method according to claim 11 wherein said step of molding comprises:
injecting said conductive loaded, resin-based material into a mold;
curing said conductive loaded, resin-based material; and
removing said conductive brush device from said mold.

17. The method according to claim 11 wherein said step of molding comprises:
loading said conductive loaded, resin-based material into a chamber;
extruding said conductive loaded, resin-based material out of said chamber through a shaping outlet; and
curing said conductive loaded, resin-based material to form said conductive brush device.

18. The method according to claim 11 further comprising the step of attaching said plurality of conductive bristles to said conductive handle.

19. The method according to claim 18 wherein said step of attaching is by an adhesive.

20. The method according to claim 18 wherein said step of attaching is by ultrasonic welding.

21. The method according to claim 18 wherein said step of attaching is by a chemical solvent.

22. A method to form a conductive brush device, said method comprising:
providing a conductive loaded, resin-based material comprising micron conductive fiber in a resin-based host wherein the percent by weight of said micron conductive fiber is between 25% and 35% of the total weight of said conductive loaded resin-based material; and
molding said conductive loaded, resin-based material into a conductive brush device comprising:
a plurality of conductive bristles; and
a conductive handle that is attached to the conductive bristles.

23. The method according to claim 22 wherein said micron conductive fiber is stainless steel.

24. The method according to claim 22 further comprising conductive powder.

25. The method according to claim 22 wherein said micron conductive fiber has a diameter of between about 3 μm and about 12 μm and a length of between about 2 mm and about 14 mm.
